(19) United States
(12) Patent Application Publication
(10) Pub. No.: US 2008/0280619 A1
(43) Pub. Date: Nov. 13, 2008

(54) Method for Transmitting Information in a Multiple Antenna System

(76) Inventors: Jin Young Chun, Seoul (KR); Bin Chul Ihm, Gyeonggni-do (KR); Yong Suk Jin, Gyeonggni-do (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/908,406

(22) PCT Filed: Aug. 16, 2005
(86) PCT No.: PCT/KR05/02670

§ 371 Date: Apr. 25, 2008

(30) Foreign Application Priority Data
Mar. 12, 2005 (KR) 10 2005 0020831

(51) Int. Cl. H04Q 7/20; H04M 1/00

(52) U.S. Cl. 455/446; 455/562.1

(57) ABSTRACT

A method of transmitting and receiving information in a wireless mobile communication system where a mobile station (MS) has at least one antenna is disclosed. More specifically, the method discloses transmitting information to a base station (BS). Here, the information includes the number of antennas to be used for transmission by the MS and whether the MS supports a collaborative spatial multiplexing (SM) scheme. Furthermore, the method discloses receiving information from the BS. Here, the information includes the number of antennas that can be used by the MS for transmission and a multi-input multi-output (MIMO) matrix to be used by each antenna of the MS.

### FIELD

The present invention relates to a method of transmitting in a wireless communication system, and more particularly, to a method of transmitting information in a multiple antenna system of a wireless communication system.

### BACKGROUND ART

With a rapid growth in the wireless mobile communication market in the recent years, a demand for different and new multimedia services in a wireless environment is increasing. In order to keep pace with such demand, companies are investing in research and development to come up with ways not only to transmit greater amount of data but at faster speeds. Furthermore, in order to provide diverse multimedia services successfully, it is important and necessary to find ways to more efficiently utilize the limited frequency resources. To resolve the limited resources problem, it has become necessary to adopt technology related to using multiple antennas, such as multiple-input, multiple-output (MIMO) system.

In the MIMO system, a base station (BS) and a mobile station (MS) each has more than one antenna for transmitting and receiving. An advantage of the MIMO system is that a diversity gain can be attained in time domain and frequency domain. In the process, for example, the MIMO system uses two methods, namely, a space-time transmit diversity (STTD) and a collaborative spatial multiplexing (SM).

The STTD is a method for attaining diversity gain by transmitting at least two signals via at least two antennas and by using time domain information. The collaborative SM is a method for allocating at least two mobile stations to a single wireless resource.

For example, when a BS has two antennas (ANT1 and ANT2), the BS can use a matrix (matrix-A) of MIMO as illustrated in Equation 1, in order to transmit signals S₁ and S₂ according to the STTD method.

$$A = \{ \begin{matrix}{S}_{1} & - {S}_{2}^{*} \\ {S}_{2} & {S}_{1}^{*}\end{matrix} \} \qquad [ Equation 1 ]$$

Here, the columns of the matrix-A represents the signals transmitted via a plurality of antennas, namely, ANT1 and ANT2, in sequential order while the rows of the matrix-A indicates time in time sequence. In detail, the signals S₁ and S₂ are respectively transmitted via ANT1 and ANT2 of a first channel, and the signals −S*₂ and S*₁ are respectively transmitted via ANT1 and ANT2 of a second channel.

Furthermore, the receiving signals, r₁ and r₂, with respect to time in the receiving end can be respectively expressed according to Equation 2.

r₁=h₁·S₁+h₂·S₂

r₂=h₁·(—S*₂)+h₂·S*₁ [Equation 2]

In the equation, h₁ and h₂ represent the status of ANT1 and ANT2, respectively.

Where the BS has two antennas, the BS can transmit signals S₁ and S₂ using the collaborative SM by using the MIMO matrix (matrix-B) as illustrated in Equation 3.

$$B = \{ \begin{matrix}{S}_{1} \\ {S}_{2}\end{matrix} \} \qquad [ Equation 3 ]$$

In the MIMO system, the BS and the MS has to share certain information (e.g., number of antennas) in order to transmit/receive signals. When a BS possess a plurality of antennas (e.g., 2-4 antennas), an IEEE 802.16e Orthogonal Frequency Division Multiplexing (OFDM) system provides the following three-types of information. They are:

The BS notifies the MS the number of antennas to be used by the BS during transmission.

The BS notifies the MS the matrix to be used by the BS during transmission.

The MS notifies the BS whether the MS has the capabilities to demodulate all the transmitted signals from the BS.

The information of above is transmitted via a SS Basic Capability Request (SBC-REQ) message. The SBC-REQ message which supports a physical parameter and/or bandwidth allocation transmitted from the MS during initialization process. In response to the SBC-REQ message, the BS transmits a SS Basic Capability Response (SBC-RSP) message. The traditional method defines a transmission method for transmitting signals (data) in a system where the BS has two to four antennas while the MS has two antennas, there is no disclosure of a transmission method of transmitting information where the MS possesses more than two antennas.

### DISCLOSURE OF INVENTION

Accordingly, the present invention is directed to a method of transmitting information in a multiple antenna system that substantially obviates one or more problems due to limitations and disadvantages of the related art.

An object of the present invention is to provide a method of transmitting information in a wireless mobile communication system where a mobile station (MS) has at least one antenna.

Another object of the present invention is to provide a method of receiving information in a wireless mobile communication system where a mobile station (MS) has at least one antenna.

A further object of the present invention is to provide a method of transmitting and receiving information in a wireless mobile communication system where a mobile station (MS) has at least one antenna.

Yet, another object of the present invention is to provide a wireless mobile communication system for transmitting information where a mobile station (MS) has at least one antenna.

Yet, another object of the present invention is to provide a wireless mobile communication system for receiving information where a mobile station (MS) has at least one antenna.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of transmitting information in a wireless mobile communication system where a mobile station (MS) has at least one antenna includes the MS which determines a number of antennas to be used for transmission and whether the MS supports a collaborative spatial multiplexing (SM) scheme. Furthermore, the MS transmits information to a base station (BS). Here, the information includes the number of antennas to be used for transmission by the MS and whether the MS supports a collaborative spatial multiplexing (SM) scheme.

In another aspect of the present invention, a method of receiving information in a wireless mobile communication system where a mobile station (MS) has at least one antenna. The method includes a base station (BS) which receives information from a mobile station (MS). Here, the information includes the number of antennas to be used for transmission by the MS and whether the MS supports a collaborative spatial multiplexing (SM) scheme.

In another aspect of the present invention, a method of transmitting and receiving information in a wireless mobile communication system is introduced. In the system, a mobile station (MS) has at least one antenna. The method include the MS for transmitting information to a base station (BS). Here, the information includes the number of antennas to be used for transmission by the MS and whether the MS supports a collaborative spatial multiplexing (SM) scheme. In addition, the BS receives the transmitted information. Thereafter, the BS transmits information to the MS. Here, the information includes the number of antennas that can be used by the MS for transmission and a multi-input multi-output (MIMO) matrix to be used by each antenna of the MS. Lastly, the MS receives the transmitted information.

In another aspect of the present invention, a wireless mobile communication system for transmitting and receiving information where a mobile station (MS) has at least one antenna is introduced. More specifically, the system includes a transmitter of the MS for transmitting information to a base station (BS). Here, the information includes the number of antennas to be used for transmission by the MS and whether the MS supports a collaborative spatial multiplexing (SM) scheme. Furthermore, a receiver of the BS for receiving the transmitted information. In addition, a system further includes a transmitter of the BS for transmitting information. Here, the information includes the number of antennas that can be used by the MS for transmission and a multi-input multi-output (MIMO) matrix to be used by each antenna of the MS. Lastly, the system includes a receiver of the MS for receiving the transmitted information form the BS.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates an example of information transmitted and received between a base station and a mobile station; and

FIG. 2 illustrates an example of information through which a base station transmits to a mobile station to notify the mobile station of which matrix to use.

FIG. 3 is an example of a structure of a wireless communication system illustrating the operation of transmitting and receiving information between the BS and the MS.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. An embodiment of the present invention relates to a method of transmitting in the MIMO system. However, the method described in the embodiment of the present invention is not limited to the MIMO system but can also apply to other wireless communication systems. Here, mobile stations in a wireless communication system include mobile stations which travel within a specified area of an access point as well as mobile stations which travel from one access point to another access point.

In the embodiment of the present invention, a method of transmitting information between a BS and a MS is provided where the MS has more than two antennas. In other words, if the MS possesses at least two antennas, in order to provide systems operation according to the number of antennas, the MS notifies the BS of the number of antennas it possesses, and in response, the BS provides the MS with the MIMO matrix for each antenna. For example, if the MS has two antennas, the MS does not have to notify the BS since the matrix for, each antenna is already determined. Moreover, with three or more antennas, the matrix for each transmission antenna is determined after the MS notifies the BS with the number of antennas to be used for transmission in the uplink direction.

The following is provided an operation for transmitting and receiving information between the BS and the MS when the MS has more than two antennas for transmission.

The MS notifies the BS with the number of antennas to be used for transmission by the MS, and the information related to whether the MS supports the STTD method or collaborative SM method. In response, the BS transmits a response message to the MS. For transmission, the SBC-REQ/SBC-RSP messages can be used.

The BS allocates the MS with which matrix each antenna has to use for transmission. Here, the matrix signifies a different MIMO matrix according to the number of the antennas. Moreover, the matrix used in the traditional multiple transmission antenna can be used without affecting the system.

After the information contained in operations (1) and (2) are stored in the BS and the MS, the information is then shared in the subsequent negotiations between the BS and the MS.

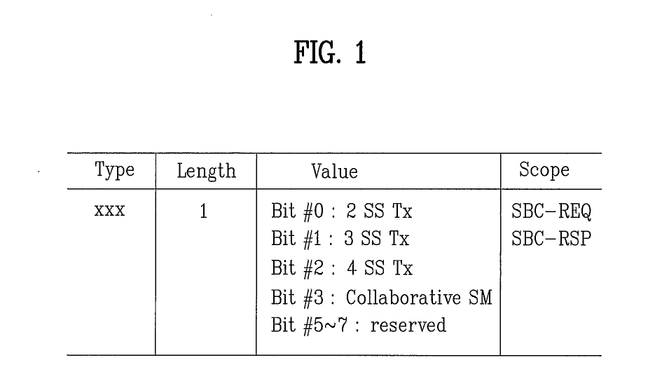

FIG. 1 illustrates an example of information transmitted and received between the BS and the MS. In FIG. 1, Bit #0-2 indicates fields by which the MS informs the BS regarding the number of antennas to be used by the MS for transmission. Additionally, Bit #3 represents a field by which the MS notifies the BS of the transmission method to be used by the MS. Here, if the value of the bit is ‘1,’ then the collaborative SM is supported, and if the value of the bit is ‘0,’ then the collaborative SM is not supported.

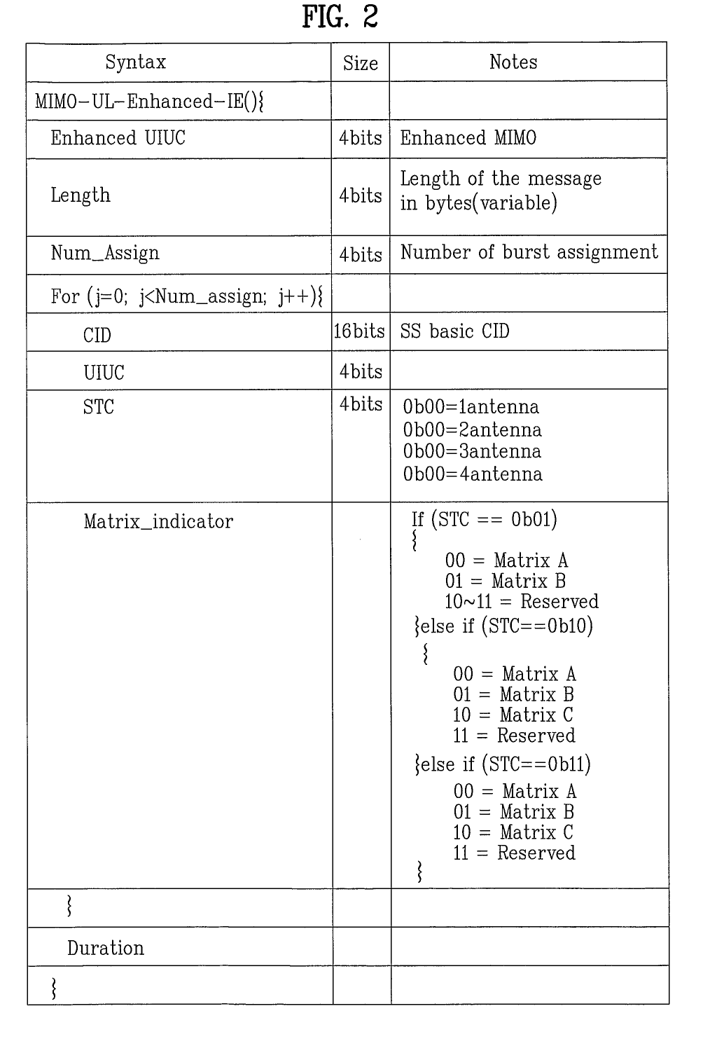

FIG. 2 illustrates an example of information through which the BS transmits to the MS to notify the MS with which matrix to use. In particular, FIG. 2 illustrates an information element from the BS via a MIMO_UL_Enhanced_IE message in order to support MIMO. Here, a Space-Time Code (STC) field indicates a number of antennas used for transmission by the MS, and a matrix_indicator field represents a MIMO matrix according to the STC.

Furthermore, the MS uses the MIMO matrix transmitted from the BS to transmit desired uplink data/information to the BS via at least two antennas.

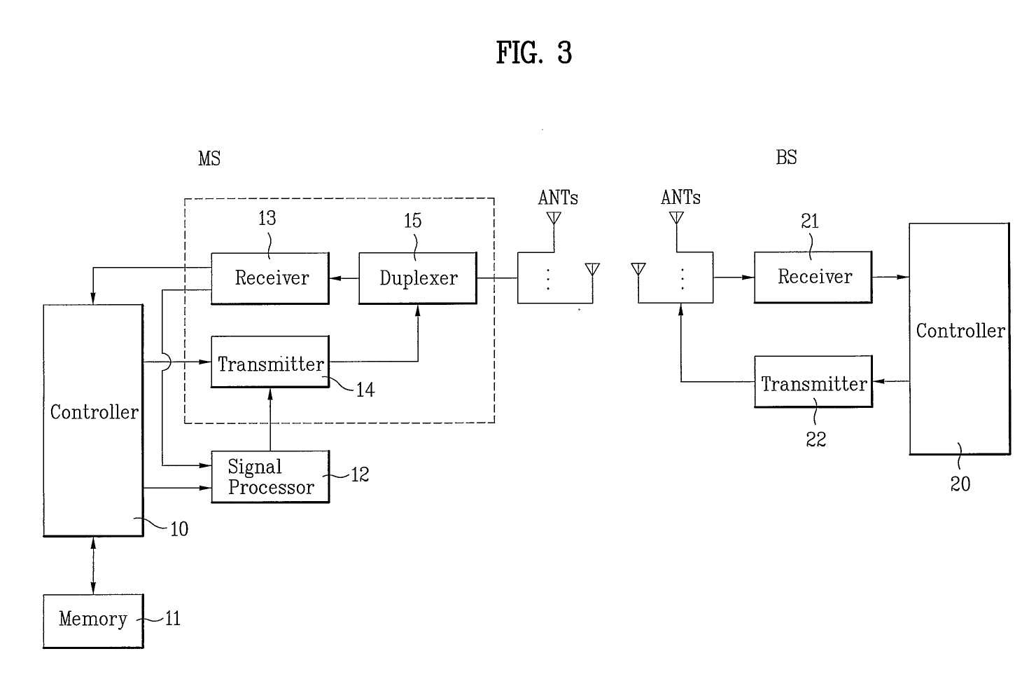

FIG. 3 is an example of a structure of a wireless communication system illustrating an operation of transmitting and receiving information between the BS and the MS. More specifically, a number of antennas to be used for transmission by the BS and the information related to whether the MS supports the STTD method or collaborative SM method are determined by the controller 10 and then transmitted via a transmitter 14 to the BS. Upon receipt of the transmitted information by a receiver 21 of the BS, a controller 20 allocates the MS with which matrix each antenna has to use for transmission.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of transmitting information in a wireless mobile communication system where a mobile station (MS) has at least one antenna, the method comprising:
determining a number of antennas to be used for transmission;
determining whether the MS supports a collaborative spatial multiplexing (SM) scheme; and
transmitting information to a base station (BS), wherein the information includes the number of antennas to be used for transmission by the MS and whether the MS supports a collaborative spatial multiplexing (SM) scheme.

2. The method of claim 1, further comprising receiving information from the BS, wherein the information includes the number of antennas that can be used by the MS for transmission and a multi-input multi-output (MIMO) matrix to be used by each antenna of the MS.

3. The method of claim 2, wherein the information related to the MIMO matrix is transmitted via a MIMO_UL_Enhanced_IE message by the BS.

4. The method of claim 2, wherein the information related to the number of antennas is transmitted via a SS Basic Capability Response (SBC-RSP) message

5. The method of claim 2, wherein the information from the BS further includes a matrix which was previously used by a BS having a plurality of transmission antennas.

6. The method of claim 1, wherein the information to the BS is transmitted via a SS Basic Capability Request (SBC-REQ) message.

7. The method of claim 1, wherein a Space-Time Transmit Diversity (STTD) scheme is used if the collaborative SM scheme is not supported by the MS.

8. The method of claim 1, wherein the BS has a plurality of transmission antennas.

9. A method of receiving information in a wireless mobile communication system where a mobile station (MS) has at least one antenna, the method comprising receiving information from the MS, wherein the information includes the number of antennas to be used for transmission by the MS and whether the MS supports a collaborative spatial multiplexing (SM) scheme.

10. The method of claim 9, further comprising transmitting information to the MS, wherein the information includes the number of antennas that can be used for transmission by the MS and a multi-input multi-output (MIMO) matrix to be used by each antenna of the MS.

11. The method of claim 10, wherein the information is transmitted via a SS Basic Capability Request (SBC-REQ) message.

12. The method of claim 10, wherein a Space-Time Transmit Diversity (STTD) scheme is used if the collaborative SM scheme is not supported by the MS.

13. The method of claim 10, wherein the BS has a plurality of transmission antennas.

14. The method of claim 9, wherein the MIMO matrix information is transmitted via a MIMO_UL_Enhanced_IE message by the BS.

15. The method of claim 9, wherein the information related to the number of antennas is transmitted via a SS Basic Capability Response (SBC-RSP) message

16. The method of claim 9, wherein the information from the BS further includes a matrix which was previously used by a BS having a plurality of transmission antennas.

17. A method of transmitting and receiving information in a wireless mobile communication system where a mobile station (MS) has at least one antenna, the method comprising:
transmitting information to a base station (BS), wherein the information includes the number of antennas to be used for transmission by the MS and whether the MS supports a collaborative spatial multiplexing (SM) scheme; receiving the transmitted information by the BS;
transmitting information to the MS, wherein the information includes the number of antennas that can be used by the MS for transmission and a multi-input multi-output (MIMO) matrix to be used by each antenna of the MS; and
receiving the transmitted information by the MS.

18. The method of claim 17, wherein the information to the BS is transmitted via a SS Basic Capability Request (SBC-REQ) message by the MS.

19. The method of claim 17, wherein a Space-Time Transmit Diversity (STTD) scheme is used if the collaborative SM scheme is not supported by the MS.

20. The method of claim 17, wherein the MIMO matrix information is transmitted via a MIMO_UL_Enhanced_IE message by the BS.

21. The method of claim 17, wherein the information related to the number of antennas is transmitted via a SS Basic Capability Response (SBC-RSP) message

22. The method of claim 17, wherein the BS has a plurality of transmission antennas.

23. The method of claim 17, wherein the information from the BS further includes a matrix which was previously used by a BS having a plurality of transmission antennas.

24. A wireless mobile communication system for transmitting and receiving information where a mobile station (MS) has at least one antenna, the system comprising:
a transmitter of the MS for transmitting information to a base station (BS), wherein the information includes the number of antennas to be used for transmission by the MS and whether the MS supports a collaborative spatial multiplexing (SM) scheme;
a receiver of the BS for receiving the transmitted information from the MS;
a transmitter of the BS for transmitting information, wherein the information includes the number of antennas that can be used by the MS for transmission and a multi-input multi-output (MIMO) matrix to be used by each antenna of the MS; and
a receiver of the MS for receiving the transmitted information from the BS.
